(19) United States
(12) Patent Application Publication
(10) Pub. No.: US 2002/0049548 A1
(43) Pub. Date: Apr. 25, 2002

(54) Chemistry resource database

(75) Inventor: Barry A. Bunin, Santa Clara, CA (US)

Correspondence Address: BEYER WEAVER & THOMAS LLP, P.O. BOX 778, BERKELEY, CA, 94704-0778, US

(73) Assignee: Libraria, Inc.

(21) Appl. No.: 09/825,135

(22) Filed: Apr. 2, 2001

Related U.S. Application Data
(60) Provisional application No. 60/194,338, filed on Apr. 3, 2000.
(60) Provisional application No. 60/198,482, filed on Apr. 18, 2000.

(51) Int. Cl. G01N 31/00; G06F 19/00

(52) U.S. Cl. 702/32; 702/30

(57) ABSTRACT

Chemical software tools employ databases and associated systems that store, manipulate, and investigate chemical information that is organized by reaction chemistry. Specific procedures and methods are associated with specific reactions. Further, such tools may associate reliability ratings with individual reactions to identify robust reactions from among groups of related reactions. For example, a particular benzyl amine may be given a high reliability rating because it is superior to other aromatic primary amines in its ability to form amides (the reaction chemistry under consideration). Further, the software tools may automatically suggest/generate diverse libraries for particular precursors, classes of precursors, or reaction chemistries. This is accomplished by automatically generating a flexible group of reaction chemistries based on like procedures and methods for a particular precursor or class of precursors. Preferably, these software tools are designed to allow continuous improvement and refinement by feedback from humans and/or artificial intelligence systems.

### CROSS-REFERENCE TO RELATED APPLICATIONS

This application claims priority under 35 USC 119(e) from U.S. Provisional Application No. 60/194,338 filed Apr. 3, 2000 and titled “System and Method for Obtaining Disease Target Solutions”; and from U.S. Provisional Application No. 60/198,482 filed Apr. 18, 2000 and titled “Tying an Evolving Database of Chemical Information to Flexible Services.” Both of these provisional applications are incorporated herein by reference for all purposes.

### BACKGROUND

The modern organic chemist has numerous software tools at her disposal. These include tools for predicting activity from chemical structure (termed “structure activity relationship” tools or SAR tools), tools for ordering commercially available reagents, and databases containing vast quantities of chemical information, including links to literature. Many of these tools have appeared recently in order to take advantage of new electronic infrastructure and electronic commerce. Others have appeared because the computational power now exists to solve (or reasonably approximate a solution to) previously intractable problems.

Some of the most widely used on-line databases provide electronically indexed data that previously appeared in textual research tools on library shelves (e.g., Beilstein, Chemical Abstracts, and the like). While such databases include various modern electronic features, they are at their heart collections of traditional chemical information reformatted for electronic databases. These existing databases are essentially lists indexing the literature with information to help the chemist decide if she wishes to obtain a particular article. As such they are not optimized to facilitate the research of a modern chemist.

One set of problems that cannot be easily addressed using current chemical software pertains to constraints on the range of reaction conditions available to a chemist. Another important issue is access to detailed information on reactivity and chemical pathways in a database formant, especially for high-throughput chemistry. Often the inherent features of a laboratory facility or piece of chemical instrumentation will constrain the range of reaction conditions available to the chemist. A good example is found in combinatorial chemistry or parallel synthesis laboratory equipment. Commonly, such apparatus is unable to provide a wide range of reaction conditions for chemical synthesis. This is because such apparatus must be designed to perform many chemical syntheses simultaneously and on very small reaction scale. Hence the apparatus is quite intricate. This intricate nature makes it difficult to provide variable heating and cooling, inert atmospheres, highly-reactive reagent delivery, etc. Further many interesting molecules are unstable to heat and/or light. If a chemist uses a software tool to suggest compounds having potentially useful activities, she would like to know whether such compounds are stable (and can in fact be synthesized) under synthesis conditions available to her. Currently, no tool provides such information. Part of the problem is that current databases do not effectively organize chemical information based on chemical reaction conditions or reaction chemistries.

Another issue arises when a chemist undertakes a new line of research and needs to use unfamiliar synthesis chemistries. In such cases, she would probably like to start with compounds that are relatively easy to synthesize. Often within a class of precursors that undergo a particular reaction, some members will undergo the reaction much more reliably than others. The chemist new to this field will wish to know which such precursors are most reliable. Similarly, an experienced chemist often comes upon reactions that intuitively should work, but in practice do not. Reaction chemistries coupled with reliability ratings can provide a powerful tool to the synthetic chemist, saving time and money which would otherwise be wasted on fruitless experiments. Unfortunately current software tools fail to conveniently provide reliability data to the chemist.

Yet another problem confronts chemists attempting to generate diverse libraries of compounds for drug discovery or other product discovery research. The literature and databases are limited in their ability to suggest the full potential of a discovery path. Often a chemist will understand that some portion of a compound (a compound fragment) is at least partially responsible for a desired activity. Such knowledge may derive from pharmacophore research, for example. In the discovery process, the chemist will wish to generate a library of compounds possessing the fragment of interest or some variant thereof. To do so, she may use combinatorial chemistry to generate a large library of compounds. In combinatorial chemistry multiple precursors, each having the desired fragment, are further elaborated through one or more syntheses. The resulting library of compounds is diverse but limited by the reaction chemistries either known to the chemist or found by searching through conventional databases. Greater diversity could be achieved if additional variations on reaction chemistry, not necessarily in the literature, were provided to the chemist.

The problems associated with the above software limitations are compounded because the pace of chemical research is ever increasing. New synthetic procedures are developed, tested, and retested daily. New insights into organic chemistry, structural biology, and drug discovery occur frequently. It is a mighty challenge for electronic repositories of chemical information to keep pace with these developments.

What is needed are improved software tools for the research chemist that facilitate chemical research.

### SUMMARY

The present invention addresses these needs by providing improved software tools that employ databases and associated systems for storing, manipulating, and investigating chemical information organized by reaction chemistries. Such tools may associate reliability ratings with individual reactions to identify robust reactions from among groups of related reactions. Similarly, these tools may allow users to apply chemical reaction condition filters when searching reaction chemistries and starting material filters when searching by structure. In a simple example, a particular benzyl amine may be given a high reliability rating because it is superior to other aromatic primary amines in its ability to form amides (the reaction chemistry under consideration). In a more complex example, reliability ratings can include ranges of reliability based on particular reaction condition filters. Further, the software tools may automatically suggest/generate diverse libraries for particular precursors, classes of precursors, or different reaction chemistries. This is accomplished by automatically generating a flexible group of reaction chemistries for a particular precursor or class of precursors. Preferably, these software tools are designed to allow continuous improvement and refinement by feedback from humans and/or artificial intelligence systems.

One aspect of this invention relates to a chemical information system for providing information pertaining to chemical syntheses. The chemical information system may be characterized by the following features: (a) a database containing chemical information organized by chemical synthesis methods; and (b) logic, configured to return information about said chemical synthesis methods in response to user queries. Importantly, the database not only has reactions organized by type, but also includes fields for reaction conditions. In this aspect of the invention, the logic can automatically generate multiple reaction chemistries for a given chemical compound. For example, it may suggest that a particular class of precursors can reliably undergo twenty-five different classes of reaction. The system of this invention may automatically generate reaction products (a library) using the reliable reactions known to it. Moreover, the generated multiple reaction chemistries can be constrained to a fixed set of reaction conditions. For example, a set of starting materials and afixed set of reaction conditions are input as a query. The logic of the invention then generates all those unique reaction types that the starting materials can undergo to afford diverse sets of different product classes under the fixed set of reaction conditions. A fixed set of reaction conditions can include ranges, for example a temperature between 25 and 40 degrees Celsius. Because a fixed set of reaction conditions can be used as part of a query to generate reaction chemistries, valuable computational time is not spent on filtering output using reaction condition filters. Although, filtering output using reaction condition filters is a valuable tool in own right, as will be discussed in detail below.

The logic provided in this system may be hardware and/or software implemented on various types of devices. The logic may function as a search engine, decision rules, etc. The chemical information used in the system may originate from various sources including experimentation and/or chemical literature, particularly peer-reviewed literature. To take full advantage of on-going developments in reaction chemistry, the system is preferably configured to link with and obtain information from one or more other chemical databases.

In addition to the elements recited above, the chemical information system may include other tools or filters such as SAR tools that predict activity of one or more chemical compounds from the database. Using such tools, the system can be used in various applications such as structural biology and drug discovery.

The chemical synthesis methods used in the database may derive from various sources. Examples include synthetic methods for organic chemistry, combinatorial chemistry, polymer synthesis, enzymatic methods, etc. Preferably, the chemical synthesis methods used in the database comprise reliability ratings.

A further aspect of the invention pertains to a method of using a chemical information system to provide chemical synthesis information to a user. Typically such method is implemented on a computing device. The method may be characterized by the following sequence: (a) receiving a query pertaining to a chemical compound or a chemical synthesis; (b) using the query to interrogate a database containing chemical information organized by chemical synthesis methods and including reliability ratings associated with said chemical synthesis methods; and (c) replying to the query with information about the chemical synthesis. The reliability ratings typically rank reactions based on factors such as reproducibility, range of suitable process conditions, yield, etc. Often the synthesis methods of interest will be used in combinatorial chemistry, polymer synthesis, or enzymatic reactions. As such, the method will find particular value in the fields of structural biology and drug discovery, for example.

In a typical example, the system will reply to a user query by identifying a library of compounds pertaining to the chemical synthesis. The library can be a specific library that has been actually synthesized, a library each of whose members all have been synthesized through independent but reliable chemistry pathways, or a virtual library based on reliable chemical reaction data. In specific embodiments, the chemical information system forms a component of a larger sales enterprise. In this context, the system may actually provide individual compounds, reagent sets for libraries, or libraries of compounds identified using the chemical information system, to a customer.

In some embodiments, the method may provide additional information to the user. For example, the method may identify a precursor of a chemical compound identified using the chemical information system. Or the method may provide a structure activity relationship tree associated with a chemical compound. These features also can be used as filters on the chemical synthesis information returned to the user.

The method may also automatically cross-reference an external database containing chemical information as well as information from the internal database according to intuitive links. For example, exact procedures to prepare related molecules are linked via structural features (such as similarity, substructure and starting material connection tables), as well as via chemistry defined ontology. Categories function to provide synthetic information automatically organized by more intuitive formats which better represent the nature of chemical reactions as well as the subjective thinking and classifications of the synthetic chemist. Specific examples include organizing chemistries by classes of starting materials (i.e. primary aromatic amines chemistries) and by classes of reaction conditions (i.e. room temperature, overnight) that are significantly more useful than current database search formats for the intuitive selection of synthetic schemes for optimizing molecular properties. As part of this operation, the method may also return reference citations specifying reaction parameters from the external database as well as reaction parameters from the internal database.

Another aspect of the invention provides a method of developing an expert system that provides chemical synthesis information. In some cases, the expert system may simply be a database and associated logic for modifying and querying the database. In this aspect of the invention, the expert system evolves or improves via feedback from one or more sources. This method may be characterized by the following sequence of operations: (a) providing a database containing chemical information organized by chemical synthesis methods; (b) using the database to identify chemical synthesis information in response to user queries; (c) based on the response to the user queries, identifying information or rules in the expert system that can be modified to improve the suitability of the expert system for providing chemical synthesis information; and (d) improving the expert system using the information identified in (c). In specific embodiment, the expert system includes chemical synthesis and SAR tools, and it is these that are improved.

The improvement may be provided by an artificial intelligence system that provides feedback on the chemical synthesis information. In addition to improving chemical synthesis information already existing in the database, the invention may add new chemical synthesis information to the database. In one example, the method adds new combinatorial synthesis methods to the database. In another example, the method adds chemical synthesis methods identified in chemical literature (preferably peer reviewed) to the database. To maintain the integrity of the database (and expert system), the method should in some way verify and/or format the new chemical synthesis methods before they are added.

Another aspect of the invention pertains to computer program products including machine-readable media on which are stored program instructions for implementing at least some portion of the methods described above. Any of the methods of this invention may be represented, in whole or in part, as program instructions that can be provided on such computer readable media. In addition, the invention pertains to various combinations of data and data structures generated and/or used as described herein.

These and other features and advantages of the present invention will be described in more detail below with reference to the associated figures.

### BRIEF DESCRIPTION OF THE DRAWINGS

FIG. 1A is a block diagram depicting how logic of the invention can generate a novel reaction sequence.

FIG. 1B is a synthetic scheme depicting how logic of the invention can provide the user with reaction sequences for maximizing diversity.

FIG. 2 is a simplified block diagram of a computer system that may be used to implement various aspects of the invention.

### DETAILED DESCRIPTION

### Introduction

The field of synthetic chemistry has evolved from observations and experiments of scientists for over a century. Chemical synthesis information has been documented in the primary literature as well as a number of reference texts. More recently combinatorial chemistry has rapidly developed as a subset of all synthetic chemistry particularly in the last decade. Combinatorial chemistry can be thought of as the most general and reliable methods for high-throughput synthesis (HTS). It often involves automation and has been likened to the industrial revolution finally meeting synthetic chemistry. The technology has increased the ability of a chemist to rapidly elucidate structure-activity relationships (in conjunction with High-Capacity Screening, HCS) but has often been under exploited for a number of reasons. Primary roadblocks include the lack of sufficient information on reliable methods for library generation and the difficulties associated with optimizing reaction conditions to provide the desired products in high yield. As will be described in more detail below, the chemo-informatics databases and software of this invention preferably include synthetic procedures with reliability ratings based on experimental data and/or other information. This invention allows one to create, organize, search, evolve, and actually use databases of synthetic information in conjunction with combinatorial chemistry. A summary of combinatorial chemistry is presented below.

### Databases Organized by Chemical Synthesis Methods

To give users great flexibility in querying by reaction chemistry and process conditions, the invention provides databases of chemical information organized by chemical synthesis methods. Generally, this means organization by reaction type. Preferably, though not necessarily, these databases are relational databases. In the databases of this invention, chemical reactions are classified according to type, reaction information, specific aspects of procedures and methods used in the reaction, product yield, reliability rating, and chemical reagents are classified according to functional group and compatible synthetic methods. In some examples, specific chemical reaction/process information is used as primary or foreign keys in relational database tables. In fact, the primary key of some database tables may be a combination of reaction type (e.g., reductive amination) and either a reactant or a product. Still further, the database keys may comprise particular reaction conditions (e.g. temperature ranges, solvent classes, pressure ranges, etc.) in association with reaction type. At a minimum, reaction types and or reaction conditions could be provided as attributes or columns of individual database records. Those of skill in the art will understand that numerous database schemas may be used to implement the functionality described below.

Conventional chemical database search engines provide examples of reaction types based on user queries. For example, if a user queries an esterification reaction generically (typically by structure or substructure), conventional systems normally provide a list of esterification reactions from the literature in no particular order or rank. More constrained queries can be input to provide more relevant examples, and hopefully reasonably short lists. Unfortunately, by putting more stringent structural restraints in the query, the user may still not retrieve the most valuable information.

As an example, consider the chemical equation below depicting a query that a user may present to a conventional database. The query uses a substructure. Substructures are fragments that define a core structural motif for which the user wishes

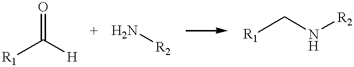

to search. In this example, the query specifies, an aldehyde fragment added to an amine fragment to yield a product. The chemical reaction is a reductive amination. As mentioned, with conventional databases, a query of this type would return every reaction in the database (sometimes several hundred or more) that conformed to the substructure fragments drawn. If a shorter list is desired, the user would have to submit a more constrained query in which the structures are more fully defined. Having used a more constrained structural query, the user is left with a more manageable list of reactions. However, this list describes only those particular literature reactions that have been loaded into the database. Thus, the user may be missing potentially valuable reaction data.

By utilizing a database of chemical reactions classified by type and of chemical reagents classified according to functional group and compatible synthetic methods, this invention can provide not only the aforementioned literature example reaction lists but also can generate examples based on literature precedent. This provides the user with non-intuitive information; that is, variations (diversity) that perhaps were not considered, even if the user is an experienced chemist.

### Maximizing Diversity

The rapid growth of automation in chemical synthesis has made a huge impact in pharmaceutical research. Automation has been integrated with in vitro testing to give High-Capacity Screening. This has led to more demand for larger chemical libraries for testing, and more importantly the drive for creation of more chemically diverse libraries. Diversity in compound structure is achieved through diversity in synthesis protocols. This invention facilitates generation of diverse synthesis protocols.

In some database designs of this invention, complete synthetic pathways (sometimes referred to as reaction schemes) as represented in the literature, are broken into the individual reactions that comprise the larger pathway. These individual reactions are separately stored or indexed in databases. This is unlike the situation with conventional chemical databases, where only complete syntheses, as reported in the literature, populate the databases. The present invention provides a more granular representation of chemical reactions. In this manner, the databases of this invention facilitate mixing and matching of individual chemical reaction steps to create new synthetic pathway. Thus, in some embodiments, the logic of the invention facilitates generation of novel synthesis schemes from the literature precedents.

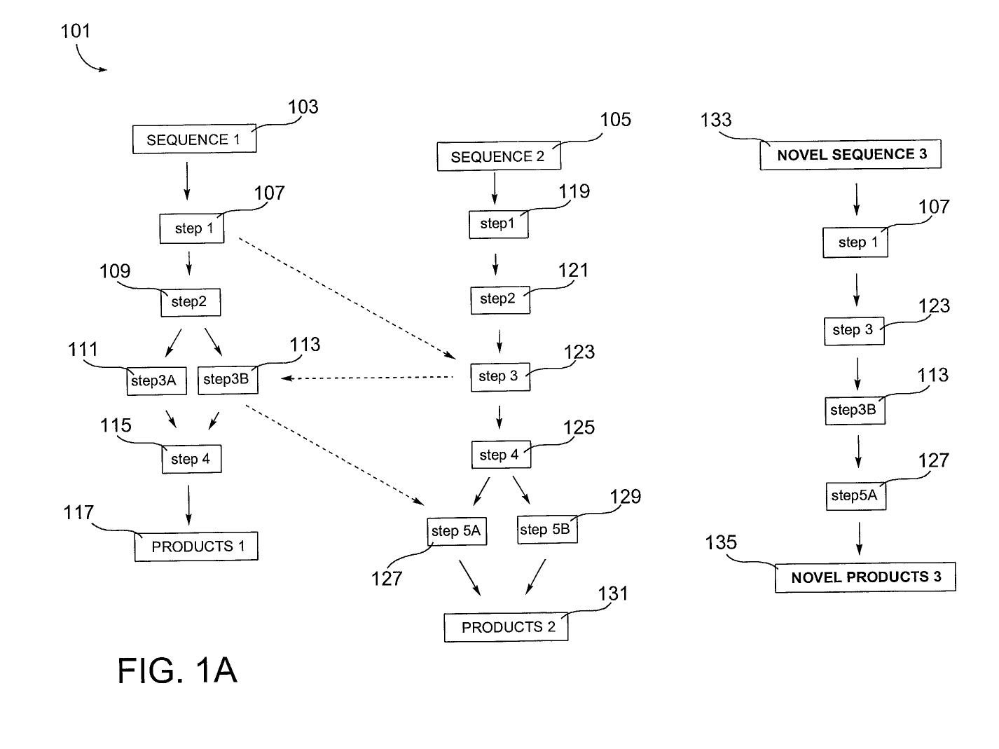

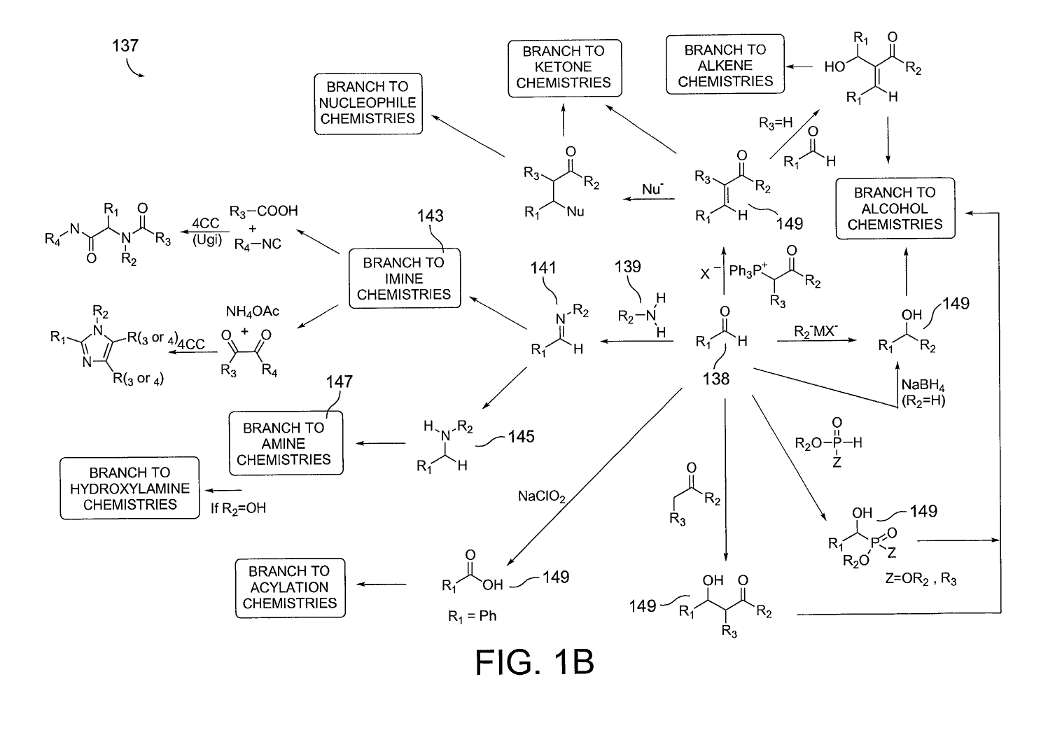

FIG. 1A is a block diagram 101 depicting how the logic of the invention may use literature precedent to generate a novel reaction sequence. Reaction sequences 103 and 105 are two examples of synthesis procedures taken from the literature and characterized in the database of the invention by the discrete reaction steps of which each consists. Each step is characterized by a unique set of conditions used to carry out that step. Sequence 103 consists of the individual steps 107-115 to give products 117. Likewise, sequence 105 consists of the individual steps 119-129 to give products 131. Using conventional databases, given the appropriate query or queries, the user may be provided with individual steps (reactions) of reaction sequences 103 and 105. Although often times reaction sequences are not provided in discrete steps, but rather with a reactant, a product, and a conglomeration of text over an arrow describing two or more steps and associated process conditions. Since sequences in the database of the invention are characterized by discrete steps and the steps are classified according to reaction type, the logic of the invention can use the steps to extrapolate from known sequences to generate novel sequences. As depicted by the dashed arrows, the logic of the invention can generate for example a new sequence 133, consisting of steps 107, 123, 113, and 127. This new sequence is generated using a “mix and match” algorithm, providing novel products 135. Many novel sequences can be generated from the many thousands of known chemical conversions in the literature. Also, a user can further massage and refine chemical information provided by the invention by application of filters, for example by specific process conditions, reliability ratings, pharmacokinetic parameters, and others as will be discussed in more detail below.

The invention also finds particular use in parallel synthesis, in that it identifies a large number of divergent synthesis protocols for a particular reagent class query. FIG. 1B depicts a system of synthetic schemes 137. The logic employed by this invention provides various reaction schemes to users automatically. Thus, the user gains access to numerous reaction sequences for maximizing diversity. For example, a generic aldehyde 138 is input as a starting reaction class. The logic of the invention generates suitable synthetic pathways for reaction of 138 to make products. In one case, aldehyde 138 is reacted with amine 139 to give imine 141. This is but one reaction branch from aldehyde 138. As shown, however, multiple reactions may be generated from the starting aldehyde 138 to yield diverse products 149. Each of these products (149 and 141) is one reaction level removed from aldehyde 138. Some or all of these compounds can be further reacted to produce even more products. For example, imine product 141 is now used as a starting reagent for chemical reactions suitable to imines, 143. Further, imine 141 can be reduced to amine 145. Amine 145 represents a set of products two steps from aldehyde 138. Likewise, amine 145 is reacted further in chemical reactions suitable to amines, see 147. These linear and branched outward growth synthesis protocols create a large diverse pool of chemical compounds, all derived from aldehyde 138. Another level of diversity stems from the fact that aldehyde 138 represents a class of aldehydes; that is, each member of that class will produce a unique product for each reaction pathway to which it is exposed. Moreover, all products resulting from and reactants used with 138 also represent classes of compounds.

As depicted, many branch points are available from any single class of reactants. Not shown is yet another level of diversity created when novel and chemically diverse intermediates and products from the reactions depicted are themselves used as starting reactants in subsequent synthesis protocols with aldehyde 138 (and other intermediates along the pathways where suitable). For example amine 145, which was synthesized from 138, could be reacted with aldehyde 138. This provides a feedback diversity level.

Yet another level of diversity includes varying the reaction conditions where suitable in the above synthesis protocols. For example a particular reaction may provide a preponderance of a different product, depending on the time allowed and temperature applied. Thus characterizing reactions in discrete steps as described above allows the logic of the invention to maximize diversity by mixing and matching reactants, intermediates, and products with synthetic steps and reaction conditions. Importantly, reliability ratings give the methods of the invention added value, in that the user has data concerning the likelihood that a given sequence will work.

### Process Condition and Activity Filters

As mentioned, constraints on the range of reaction (process) conditions cannot be easily addressed using current chemical software available to a chemist. When reaction conditions need to be constrained due to a limitation of a synthesis apparatus or lability of a reagent or product in the synthesis, for example, process condition filters of the invention can provide chemical information pertaining to the user's unique process constraints. This feature reduces or eliminates unnecessary methodology research, thereby saving time and valuable resources. Further, using reaction condition filters together with reaction data classified by type, the user can use the invention to design new libraries based on constraints particular to her parallel synthesis apparatus. For example, a chemist knows that her apparatus can only perform reactions at room temperature and with no inert atmosphere; she can input these as reaction condition constraints. She can also input reactant or product constraints; for example the starting reagents being secondary amines. The chemist (user) inputs these constraints, and the invention provides a list of reactions (from the literature and generated by logic, vida supra) that can be performed with secondary amines at room temperature and without the need for an inert atmosphere.

Also, the reactions can be sorted by type, so that the user need not manually sift through the list to find reactions of the same type. Her compound library can therefore consist of compounds synthesized using those reactions in the list provided by the invention or a chosen subset of the list. Also, since each of the reactions in the database has been typed, its constituent reactants and products have been tagged by type. This means that for each member of a particular reagent class, for example aldehydes, ketones, amines, etc., there is an annotation (tag) made in the database. Therefore the user can use the list of reactions to compile reagent tags in order to generate lists containing reagents of a particular class. This is important, because reagents are more conveniently used in library synthesis and stored, by class. For example, acid chlorides are often volatile, require refrigeration, and ventilation; more benign reagent sets can be stored under less stringent storage protocols.

The software tools of this invention may also include filters that require compounds to possess certain levels of activity. Pharmacophore analysis and SAR tools are examples of such tools. These tools may predict effectiveness based on binding with a target, for example. Other tools may be employed to predict ADMET (Adsorption, Distribution, Metabolism, Excretion, Toxicity) properties. Compounds proposed by one software tool are analyzed by one or more filtering tools that predict activity from structure. If the predicted activity of a proposed compound does not meet an activity threshold specified by a filter, then that compound may be rejected or given lower priority by the system.

One type of ADMET related filter may apply standard rules of thumb to select potential compounds. Typically, pharmaceutical companies seek orally available drugs because those are the most accepted by the public i.e. those drugs that can be formulated and administered in “pill” form. Before any compound can be considered as an orally available drug candidate, its pharmacokinetic profile must be determined. From available pharmacological data, a set of rules for determining bioavailability of compounds as a function of structural parameters has been formulated. These rules are known as the “Lipinski Rule of Five,” which generally relate bodily absorption of compounds through the gut wall to the compounds' molecular weight, number of heteroatoms, lipophilicity, and so on. These rules and other predictive structure-related pharmacological trends are used as an additional filter option to the user, giving yet another level of value in compound or compound library design. Not only does the user obtain synthesis data coupled with reliability data, but also the reliable chemistries can be filtered so that only pharmacologically relevant compounds are made. This saves valuable chemistry and pharmacology resources.

### Reliability Ratings

In a particular embodiment of the invention, chemical reactions and reactants are given reliability ratings. Based on known reliable chemical reaction data, peer-reviewed chemistry, and ongoing reliability testing, chemical reactions and reactants are catalogued with associated reliability data. These data form the basis for reliability ratings, ranking reactions based on reproducibility, range of suitable process conditions, yield, and the like.

As mentioned above, the invention can generate reaction examples based on literature precedent. Incorporation of reliability data into such algorithms provides the user with confidence margins that the proposed chemistries will work. In one example, the user can input an acceptable desired confidence level as a filter. The output of generated reactions would then include only those reactions with acceptable reliability ratings. All reactions are grouped not only by type, but also by source, that is, whether from literature example or generation via logic of the invention. Logically generated reaction data include reliability ratings that take into account extrapolated error probability factors.

Reliability ratings are not only important for the user as descriptors of chemical reactions as whole entities, but also as predictors for identifying reaction types available to the user for a particular starting reagent. For example, based on an initial query, the invention can suggest that a particular precursor or class of precursors can reliably undergo multiple types of reaction, that is, without actually retrieving or generating such reactions. The user can use this predictive information to tailor a subsequent query, more relevant to her library design plan, for example considering the reagents available to her at the time.

### Feedback Systems for Evolving Chemical Databases and Expert Systems

As indicated, some embodiments of this invention make use of expert systems and Artificial Intelligence. The roots of Artificial Intelligence can be traced to the now famous Turing test for computer intelligence. The basic postulate is that rather than ask if computers can think, the more testable question is given a series of questions can an interrogator determine if the typewritten answers are coming from a human or a computer. A wealth of early studies in the field can be found in the classic book “Computers and Thoughts” for more detailed background; Feigenbaum, E. A.; Feldman, J. “Computers and Thought” AAAI Press Edition, 1995, Menlo Park, first published in 1963 by McGraw-Hill Book Company. This reference is incorporated herein by reference, in its entirety, and for all purposes.

Ironically, one of the first applications (expert systems) to use Al was the Dendral project that assisted with molecular structure identification based on mass spectroscopy data. In the Dendral program, a collaboration was initiated between Feigenbaum, Lederberg, Buchanan, and Djerassi to elucidate chemical structure at a high level of competence. Given a molecular formula, the spectrographic data, and encoded heuristic knowledge of organic chemists, the Dendral interactive program explores possible molecular configurations in the search for the true structure. The project helped elucidate some of the basic mechanisms of hypothesis generation and evaluation. The results of the project suggested that knowledge was as important as reasoning in these systems. In any case, today there are many examples where artificial intelligence has been used to generate expert systems with varying degrees of success.

Expert systems attempt to replicate the decision making process of a human expert in a limited field. It consists of three components: a knowledge base, decision rules, and an inference engine. The databases and knowledge bases described above may be used in the expert systems of this invention. As with all developing technologies, without an appropriate problem they are academic endeavors. The real utility involves how a technology (in this invention evolving technologies of artificial intelligence and combinatorial chemistry) is applied to a specific problem.

A few examples of current advances that may be used in the feedback-directed optimization for databases of this invention include web industry technology, multi-agent teams, the human/computer interfaces, and inductive learning in flexible hypothesis space; see MIT CBCL and Al lab cosponsored “Spring 2000 Brains and Machines Seminar Series” February 23 Tom Mitchell “Supervised Learning from Unlabeled Data”; Kaminka, G. A.; Tambe, M. J. Artificial Intelligence 2000, 12, 105-147; “Human factors in Information Systems: An Organizational Perspective,” Ed. Carey, J. M. Ablex Publishing, Corp. 1991, Norwood NJ; and “A Model of Inductive Bias Learning,” J. Artificial Intelligence 2000, 12, 149-198. The use of such advances in the reasoning component of a chemical database can receive human checks and balances, at least initially. Each of these references is incorporated herein by reference for all purposes.

Some systems of this invention grow information databases and will search information databases with a team of scientists and artificial intelligence capabilities starting with combinatorial chemistry (the most general and reliable synthetic methods). These systems employ feedback loops that help both groups learn. To maintain relevance at each step the information can be evaluated and corrected by humans and computer programs until it is evident which is better suited for which specific tasks. This is done with crossover of information so both teams collaborate and compete. At every stage, practical the information system may be tied to real services (for example, the synthesis of libraries and individual compounds).

A key to expanding the systems is to make them open and compatible with outside parties. This approach is applicable to developing the database, developing the search engines, developing the basic technologies (both AI and chemical), and interacting with other databases. The epitome of this approach is the Internet. Third parties may contribute to content, basic research, and software architecture. Part of the architecture of the software may include a filter of suggestions and additional contributions.

A book is a static database. It contains information, but has no ability to evolve its internal structure once the book is printed. An intermediate level is a software database that provides the user with a number of options to choose from and a number of possible answers to queries. The more advanced expert systems of this invention continuously evolve based on feedback loops. For example, a database initially populated with chemical information from the Electronic Combinatorial Index (incorporated by reference below) can evolve into something much greater than the initial static product. Procedures for combinatorial chemistry represent a subset of all synthesis, procedures for synthesis represent a cross section of procedures for drug discovery, procedures for drug discovery are a cross section of all chemistry and biology. The relevant architecture may contain both procedures (information) and deliverables (services) at multiple stages. The internal connections become stronger as they are used and the number of external connections increase somewhat like the development of an embryonic brain.

In the evolutionary hierarchy, a central position may be occupied by a set of reliable methods for high-throughput combinatorial synthesis. This is analogous to the relationship combinatorial synthesis has to all synthetic methods. As previously mentioned, combinatorial synthesis represents the most general, expedient and robust synthetic methods because by their very nature they should be tolerant of a range of functional groups. While this central position grows over time as additional scientists publish on combinatorial methods, the real growth in the database results from the tentacles that reach into the more mature field of chemical synthesis as rather broadly defined. The second position includes the most widely used chemistry referenced books judiciously selected. The procedures from the leading references are included along with their lineage to the more general high-throughput synthesis methods. Examples of appropriate reference works for the second circle include, but are not limited to March's Advanced Organic Chemistry: Reactions, Mechanisms, and Structure, 5th Edition; Smith, M. B.; March, J.; John Wiley & Sons: New York, 2001; Protective Groups in Organic Synthesis; Wuts, P. G. M.; Greene, T. W.; John Wiley & Sons: New York, 1999; The Practice of Peptide Synthesis; Bodanszky, M.; Bodanszky, A.; Springer Verlag, Heidelberg, 1984; and Encyclopedia of Reagents for Organic Synthesis; Paquette, L. A., Ed.; John Wiley & Sons: Chichester, UK, 1995. All of the facts and information from texts are reformatted in a uniform simple manner for easy access by humans and computer programs and to avoid any copyright restrictions. Other reference texts that can be added to the second circle, include but are not limited to Organic Syntheses; Freeman, J. P., Ed.; John Wiley & Sons; Organic Reactions; Paquette, L. A., Ed.; John Wiley & Sons; and Comprehensive Heterocyclic Chemistry; Katritzky, A. R.; Pergamon Press. Each of the resources identified in this paragraph is incorporated herein by reference in its entirety and for all purposes.

A third circle may include the leading references from the first two circles. When appropriate, this leads to a chain of articles. A fourth circle may involve a systematic reorganization of some or all of the chemical literature in the journals. Reorganizing the information in a common format will have obvious advantages for the end user. This is superficially similar to formatting provided by Chemical Abstracts, except that it may emphasize procedures, and/or tie them to services, and make them part of an evolving database. By having the structural and reaction information stored in a uniform manner, both chemists and AI programs can get used to improving the system and making connections. Each time a human expert finds a new connection she will notify the computer program and vice versa.

Once the inner circles reach a certain mass inertia, other databases may be incorporated. This involves the use of robust search agents at the early stage of the project that are able to search other databases and vice-versa. A key to utility will be in the organization of the material and the simplicity (with enormous flexibility) of the search engine. Further, the system may include search agents to search for information. These may be guided by both an artificial intelligence program and human experts in chemical database mining.

The methods for organization, representation, and uses of databases described herein are applicable to both related and unrelated fields of knowledge.

### Ancillary Features

In addition, to providing information such as synthetic procedures with reliability ratings, the chemo-informatics tools of this invention may include various ancillary features such as services. In one example, all chemical information is one click away from a “shared risk” feasibility study and custom services. The services include but are not limited to the delivery of individual compounds, small libraries (bookends of 10-100), and large libraries (1000-100,000).

With our general diversity and targeted libraries, the services may include providing first generation actual and virtual libraries. The libraries may come with software for SAR trees describing follow-on libraries. This includes the option of using other software and biasing the SAR trees describing follow-on libraries with known structural information. As another example, instead of having a follow-on library with just the same reactions (which is the most straightforward approach both scientifically and logistically), have software programs and/or humans select from a range of chemistries with reliability ratings for either diverse or targeted sets of library products and services.

In one example, each set of 2000 compounds (2D library) and 6000 compounds (3D library) on average will come with an option for a second generation library based on the SAR or a full blown-out library (perhaps in a split and mix format) if the customer wishes to hide the SAR. Both human and Al teams can collaborate and compete on the reaction condition optimization and SAR optimization problems.

The informatics package can be linked to a network of cross-references to suggest related sets of compounds for synthesis. For example, a section from March's Organic Chemistry text might lead to series of papers that suggest a particular set of reaction conditions. Both the computer and humans can find patterns of “leading references”. As indicated above, these may be associated with reliability ratings. The data output preferably includes references, words, and schemes as provided by current chemical databases such as Beilstein while including addition outputs such as procedures and the potential to have a compound described in the literature made for the customer and delivered (following shared-risk feasibility). The customer has the option of using only information, only the synthetic services, or a combination of the two offerings.

The information and database services can be extended to include analytical data (theoretical and/or experimental), structural data on the molecules, bio-structural data for more complex problems, chemical ordering information, and web-offerings. These are all related fields under the umbrella of drug discovery.

There are a number of offerings that have demonstrated the utility of open systems that leverage the efforts of others. In chemistry, SciQuest (of Research Triangle Park, N.C.), ChemNavigator (of San Diego, Calif.), and Cambridge Soft's (of Cambridge, Mass.) web portals are more recent examples. Historically, the Aldrich chemical catalog lists chemicals that are bought elsewhere and rebottled or made in house with the same result for the customer. To the appropriate extent, the service offerings of this invention will take into account a range of requests and then search the world's database of synthetic information for appropriate solutions.

Another way to tie information to services is to organize flexible sets of precursors based on structural criteria in the literature (see, Lipinski, C, et al and Murcko, M. et al). These criteria can be organized in a uniform, yet uniquely flexible organization of the data input variables for library generation (both for individual libraries or groups of libraries as described in the fast example). For example, the precursors can be organized and bar-coded in rows and columns of a grid such as the industry standard 96-well microtiter plate. Additional information can be added to the precursor sets prior to internal or external use including but not limited to solubility data, reliability ratings (+/− or 1-10), aromatic/aliphatic, diverse/targeted, hydrophobic/hydrophilic, alpha/beta substituted, o-, m-, p-substituted, ring size, bicyclic/fused, etc. Customers have the option of using the software tools or their own in the selection process. They can test the chemistry in their own laboratory (one place) with a subset of precursors and then have the service provider generate the full library (second place) because of the careful pre-organization and pre-selection of appropriate data input precursors. The pre-organization of these sets of precursors facilitates “shared risk” rapid feasibility studies on precursor compatibility with new chemistries.

The pre-organization of both synthetic information and structurally relevant precursor sets allows for more flexible chemical services. These can range from individual compound synthesis, to small sets (bookends), to large sets (full libraries). A key to this is the large database or expert system containing intelligently organized, flexible chemical information to offer the greatest range of services. The guiding principles can be applied to other related and unrelated fields.

### Software/Hardware

Generally, embodiments of the present invention employ various processes involving data stored in or transferred through one or more computer systems. Embodiments of the present invention also relate to an apparatus for performing these operations. This apparatus may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps. A particular structure for a variety of these machines will appear from the description given below.

In addition, embodiments of the present invention relate to computer readable media or computer program products that include program instructions and/or data (including data structures) for performing various computer-implemented operations. Examples of computer-readable media include, but are not limited to, magnetic media such as hard disks, floppy disks, and magnetic tape; optical media such as CD-ROM disks; magneto-optical media; semiconductor memory devices, and hardware devices that are specially configured to store and perform program instructions, such as read-only memory devices (ROM) and random access memory (RAM). The data and program instructions of this invention may also be embodied on a carrier wave or other transport medium. Examples of program instructions include both machine code, such as produced by a compiler, and files containing higher level code that may be executed by the computer using an interpreter.

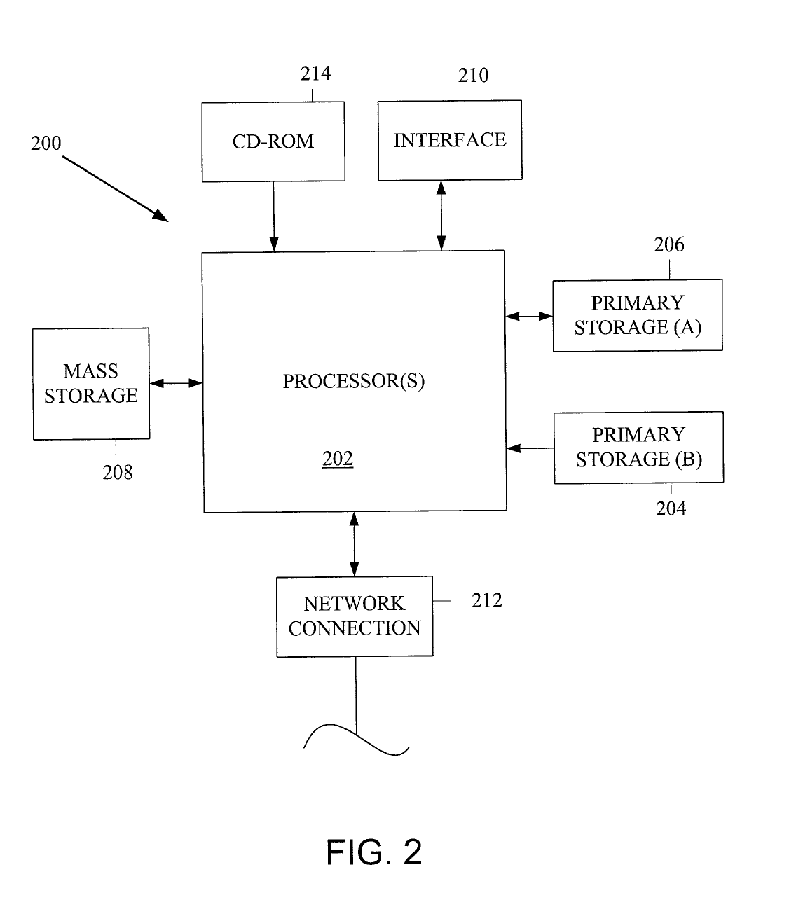

FIG. 2 illustrates, in simple block format, a typical computer system that, when appropriately configured or designed, can serve as an image analysis apparatus of this invention. The computer system 200 includes any number of processors 202 (also referred to as central processing units, or CPUs) that are coupled to storage devices including primary storage 206 (typically a random access memory, or RAM), primary storage 204 (typically a read only memory, or ROM). CPU 202 may be of various types including microcontrollers and microprocessors such as programmable devices (e.g., CPLDs and FPGAs) and unprogrammable devices such as gate array ASICs or general purpose microprocessors. As is well known in the art, primary storage 204 acts to transfer data and instructions uni-directionally to the CPU and primary storage 206 is used typically to transfer data and instructions in a bi-directional manner. Both of these primary storage devices may include any suitable computer-readable media such as those described above. A mass storage device 208 is also coupled bi-directionally to CPU 202 and provides additional data storage capacity and may include any of the computer-readable media described above. Mass storage device 208 may be used to store programs, data and the like and is typically a secondary storage medium such as a hard disk. It will be appreciated that the information retained within the mass storage device 208, may, in appropriate cases, be incorporated in standard fashion as part of primary storage 206 as virtual memory. A specific mass storage device such as a CD-ROM 214 may also pass data uni-directionally to the CPU.

CPU 202 is also coupled to an interface 210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 202 optionally may be coupled to an external device such as a database or a computer or telecommunications network using an external connection as shown generally at 212. With such a connection, it is contemplated that the CPU might receive information from the network, or might output information to the network in the course of performing the method steps described herein.

In one embodiment, the computer system 200 is configured as a database and database management system for chemical information organized as described herein. The chemical information may derive from various sources. Remote sources of chemical information may provide the information to system 200 via interface 212.

Once in the apparatus 200, a memory device such as primary storage 206 or mass storage 208 stores the chemical information. The memory may also store various routines and/or programs for analyzing and presenting the data. Such programs/routines may include database management systems, programs for performing populating databases with new chemical information, tools for improving the performance of databases, etc.

### Summary of Combinatorial Chemistry

Note that the following pages are derived from the early chapters of the widely used text on combinatorial chemistry Bunin, B. A. The Combinatorial Index, 1998, Academic Press. This text is incorporated herein by reference, in its entirety, and for all purposes.

The synthesis and screening of libraries of nonbiological oligomers and nonpolymeric organic compounds (“small molecules”) have rapidly become the focus of intensive research efforts. Many combinatorial libraries are currently constructed using solid phase synthesis. Although many reactions on support are high yielding, significant optimization is often required before they are efficient and general enough to be used to construct combinatorial libraries. Reliable methods for reactions such as substitutions, cyclizations, condensations, and Suzuki couplings are particularly useful with this invention because they can be used in different contexts.

Doing organic chemistry on solid support has been likened to working with a blindfold on because of the limited analytical and, purification techniques available relative to those available in solution. This is one of the arguments in favor of building libraries in solution. The most direct way to evaluate the fate of a particular set of reaction conditions on support is to cleave the material off of support and rigorously characterize the products. Unfortunately, this is not always possible because intermediates are often unstable to cleavage conditions. Furthermore, particularly in a multistep sequence, there are often faster methods for determining whether a particular reaction worked (i.e., FMOC quantitation).

A growing number of reports on solution libraries have appeared in the literature. Whether a library is prepared on support or in solution is often dictated by the type of chemistry being developed (or vice versa, the type of chemistry being developed is often dictated by whether a library is prepared on support or in solution). High-throughput purification techniques such as solid-phase and liquid-phase extractions are often critical for preparing solution libraries that are useful for screening. The challenges associated with the construction of solution libraries (e.g., solubility and purification) can be quite different from the challenges associated with solid-phase combinatorial synthesis (e.g., monitoring reaction progress and scale up). Although there are many differences between the solution-phase and solid-phase strategies for generating libraries, in both cases the synthetic challenge is to develop reaction conditions that are general and high yielding.

A salient feature of combinatorial synthesis is that a large amount of diversity can be generated from a relatively small number of building blocks. A representative example is a simple combinatorial library prepared on solid support from three sets of building blocks, A, B, and C. From only 10 derivatives of each building block, a library of 1000 trimers can be generated; with 100 derivatives of each building block, 1,000,000 compounds can be accessed. With rapid access to such large numbers of compounds, new issues arise such as which compounds are the most useful to make and how to keep track of the large amount of information that is generated.

Currently, there are a number of distinct approaches for generating combinatorial libraries in vitro. The compounds can be synthesized in a spatially separate format or as pooled mixtures. A number of methods for identifying active compounds in a mixture have been developed. Obviously, identifying an active compound is straightforward when the compounds are synthesized in a spatially separate format.

The most straightforward approach for library analysis is to keep the different compounds (or other variables) spatially separate in a parallel array. The primary advantage of keeping the compounds spatially separate is that it removes some of the ambiguities associated with pooling compounds. When the compounds are spatially separate, direct structure-activity relationships are obtained from biological evaluation. Analytical evaluation of the chemical integrity of the compounds is also straightforward when the compounds are spatially separate. The primary disadvantage of spatially separate libraries is that the number of compounds that can be synthesized is more limited.

The first combinatorial library was prepared in a spatially separate format by Geysen and co-workers in 1984; Geysen, H. M; Meloen, R H. Barteling, S. J. Proc. Natl. Acad. Sci. USA. 1984, 81, 3998-4002. They developed functionalized pins for solid phase peptide synthesis and epitope analysis. The pins were configured to be compatible with 96-well microtiter plates. The pin technology has been improved using different polymers, as well as higher loading levels and functional linkers to accommodate other chemical applications. Fodor and co-workers at Affymax have developed photolithographic methods for building large libraries on a silicon wafer; Fodor, S. P. A.; Read, J. L.; Pirrung, M. C.; Stryer, L.; Lu, A. T.; Solas, D. Science 1991, 251, 767-773. Large spatially separate libraries (100,000 compounds) can be prepared with this method. However, because it requires photolabile protecting groups and support bound biological assays, the technology is primarily being applied to DNA diagnostic tests. A number of new technologies for the preparation of spatially separate libraries on resin and in solution are currently being developed.

There are a number of different pooling strategies. The earliest of these, developed independently by Furka, Lam, and Houghten, employ a split and mix procedure to generate mixtures of peptides; Furka, A.; Sebestyen, F.; Asgedom, M.; Dibo, G. Int. J. Pept. Protein Res. 1991, 37, 487-493; Lam, K. S.; Salmon, S. E.; Hersh, E. M.; Hruby, V. J.; Kazmierski, W. M.; Knapp, R J. Nature 1991, 351, 82-84; Houghten, R A.; Pinilla, C.; Blondelle, S. E.; Appel, 7. R.; Dooley, C. T.; Cuervo, J. H. Nature 1991,354, 84-86. In a split synthesis, a quantity of resin is split into equal-sized portions in separate reaction vessels and reacted with different monomers. After the reactions are complete, the resin is pooled together and thoroughly mixed. A common protecting group can be removed, or a common transformation can be performed, in a single reaction vessel. For the coupling of a second monomer, the resin is split again, and the process is repeated until the end of the combinatorial synthesis. To couple different building blocks, such as activated amino acids, the resin must be split into separate reaction vessels to allow reactions with different rates to be driven to completion.

There are a number of techniques for identifying biologically active components from a library prepared by a split synthesis. The active components in a mixture can be isolated by deconvolution studies such as an iterative resynthesis and evaluation of smaller pools. A portion of the resin can be saved at each step to facilitate the iterative resynthesis. In addition, orthogonal, positional, and indexed libraries all use pooling strategies that minimize the amount of deconvolution required.

The combinatorial methods initially developed for peptide synthesis have also been applied to the combinatorial synthesis of unnatural biopolymers and small molecules. In one early example, high-affinity ligands to 7-transmembrane G-protein-coupled receptors (7TM/GPCR) were identified from the split synthesis of a diverse peptoid library.

At the end of any split synthesis, each individual bead theoretically contains a single product, since all of the sites on any particular bead have been exposed to the same synthetic reagents. “One compound, one bead” approaches have been developed to identify the active components in a biological assay without resorting to a time-consuming iterative resynthesis. With certain assays of support bound compounds, an active compound from a single resin bead is identified after it binds with a radiolabeled or fluorescent-labeled receptor. After active components on support are detected and isolated, the chemical structure can be determined using a method such as Edman degradation for the identification of support bound peptides. Methods for the partial release of compounds off the support have been developed for biological evaluation in solution. After biological evaluation, the compound that remains on the resin beads can be used for structural identification.

A conceptually different approach to deconvoluting active components from a library prepared by split synthesis involves a molecular tagging scheme. In this approach, readable tags that encode the reaction sequence are attached to resin. DNA was an obvious choice for encoding, since that is what Nature uses. Unfortunately, DNA is not chemically stable under many of the reaction conditions frequently used in organic synthesis. To circumvent this problem, encoding has been performed with peptides prepared from amino acids that have relatively unreactive side chains or GC-EC tags that are inert to most of the reaction conditions typically employed. The advantages of the GC-EC tags, developed by Still and co-workers, are that they can be both detected at less than 0.1 pmol and attached directly to polystyrene via carbene chemistry; Ohlmeyer, M. H.; Swanson, R N.; Dillard, L. W.; Reader, J. C.; Asouline, G.; Kobayashi, R; Wigler, M.; Still, W. C. Proc. Natl. Acad. Sci. USA. 1993, 90, 10922-10926. Thus, the method does not require an orthogonal protecting strategy. Radio frequency tagging strategies have also been developed as an alternative method for encoding libraries on resin. Alternative approaches to generating combinatorial libraries and optimizing biological activity, such as genetic algorithms, are currently being investigated.

At least as important as the format in which libraries are prepared are the classes of compounds that are accessible. One aspect of this invention involves expanding the chemical reaction information from the “The Combinatorial Index” to a suite of software products and services. Further the invention involves expanding an initial database on combinatorial chemistry to incorporate all synthetic chemistry. Another key component is incorporation of flexible services as part of the software package. The way in which the database will evolve is another component. This ties in with related emerging fields of artificial intelligence.

### Conclusion

Although the above has generally described the present invention according to specific processes and apparatus, the present invention has a much broader range of applicability. In particular, the present invention has been described in terms of combinatorial chemistry and chemical synthetic pathways, but is not so limited. The databases and software systems described herein may be more generally applied to drug discovery and structural biology, as well as other fields such as psychology, law, engineering, architecture, journalism, economics, history, business, electronics, and the internet to mention some possibilities. Of course, one of ordinary skill in the art would recognize other variations, modifications, and alternatives.

What is claimed is:

1. A method of developing an expert system for providing chemical synthesis information, the method comprising:
(a) providing a database containing chemical information organized by chemical synthesis methods;
(b) using the database to identify chemical synthesis information in response to user queries;
(c) based on the response to the user queries, identifying information or rules in the expert system that are modified to improve the suitability of the expert system for providing chemical synthesis information; and
(d) improving the expert system using the information identified in (c).

2. The method of claim 1, wherein organization by synthesis methods includes organization by reaction conditions and starting materials.

3. The method of claim 1, wherein an artificial intelligence system provides feedback on the chemical synthesis information to improve the database.

4. The method of claim 1, wherein the chemical synthesis methods comprise combinatorial synthesis methods.

5. The method of claim 1, further comprising adding new combinatorial synthesis methods to the database.

6. The method of claim 1, further comprising adding chemical synthesis methods identified in chemical literature to the database.

7. The method of claim 6, wherein the chemical literature is peer reviewed literature.

8. The method of claim 6, further comprising adding new chemical synthesis methods to the database after verifying the new chemical synthesis methods.

9. The method of claim 6, further comprising formatting said chemical methods prior to adding them to the database.

10. The method of claim 1, wherein the expert system includes SAR tools.

11. The method of claim 10, wherein the SAR tools are improved based on the identified information or rules in the expert system that can be modified to improve the suitability of the expert system for providing chemical synthesis information.

12. A chemical information system for providing information pertaining to chemical syntheses, the chemical information system comprising:
a database containing chemical information organized by chemical synthesis methods; and
logic configured to return information about said chemical synthesis methods in response to user queries, wherein the logic can automatically generate multiple reaction chemistries for a given chemical compound.

13. The chemical information system of claim 12, wherein the database system is capable of interacting with other databases containing chemical information.

14. The chemical information system of claim 12, further comprising a link to one or more other chemical databases containing chemical information.

15. The chemical information system of claim 12, wherein the chemical synthesis methods comprise combinatorial chemical methods.

16. The chemical information system of claim 12, wherein the chemical information originates at least in part from chemical literature.

17. The method of claim 16, wherein the chemical literature is peer reviewed literature.

18. The chemical information system of claim 12, wherein the chemical synthesis methods used in the database comprise reliability ratings.

19. The chemical information system of claim 12, further comprising SAR tools that predict activity of one or more chemical compounds from the database.

20. The chemical information system of claim 12, wherein the chemical synthesis methods comprise methods for polymer synthesis.

21. The chemical information system of claim 12, wherein the chemical synthesis methods comprise enzyme mediated methods.

22. The chemical information system of claim 12, wherein the logic comprises a search engine.

23. The chemical information system of claim 12, wherein the logic comprises decision rules.

24. The chemical information system of claim 12, wherein the user queries are constrained to a fixed set of reaction conditions.

25. A method of using a chemical information system to provide chemical synthesis information to a user, the method comprising:
(a) receiving a query pertaining to a chemical compound or a chemical synthesis;
(b) using the query to interrogate a database containing chemical information organized by chemical synthesis methods and including reliability ratings associated with said chemical synthesis methods; and
(c) replying to the query with information about the chemical synthesis.

26. The method of claim 25, further comprising identifying a library of compounds pertaining to the chemical synthesis.

27. The method of claim 26 further comprising providing the library of compounds to a customer.

28. The method of claim 25, further comprising providing individual compounds identified using the chemical information system.

29. The method of claim 25, further comprising identifying a precursor of a chemical compound identified using the chemical information system.

30. The method of claim 25, further comprising providing a structure activity relationship tree to a customer.

31. The method of claim 25, wherein the chemical synthesis methods comprise combinatorial synthetic methods.

32. The method of claim 25, further comprising automatically cross-referencing an external database containing chemical information.

33. The method of claim 32, further comprising obtaining reference citations specifying reaction parameters from the external database.

34. The method of claim 25, further comprising automatically cross-referencing the database according to intuitive links.

35. The method of claim 25, further comprising organizing the database according to reaction parameters.

36. The method of claim 25, wherein the chemical synthesis methods comprise methods for polymer synthesis.

37. The method of claim 25, wherein the chemical synthesis methods comprise enzyme mediated methods.
